(19) United States
(12) Patent Application Publication
(10) Pub. No.: US 2024/0127358 A1
(43) Pub. Date: Apr. 18, 2024

(54) AUTOMATED PREAUTHORIZATION USING BLOCKCHAIN

(71) Applicant: BrainX, LLC, Broadview Heights, OH (US)

(72) Inventors: Piyush MATHUR, Broadview Heights, OH (US); Francis A. PAPAY, Westlake, OH (US); Kamal MAHESHWARI, Solon, OH (US); Ashish K. KHANNA, Winston-Salem, NC (US); Jacek B. CYWINSKI, Broadview Heights, OH (US)

(21) Appl. No.: 18/486,782

(22) Filed: Oct. 13, 2023

Related U.S. Application Data
(60) Provisional application No. 63/379,760, filed on Oct. 16, 2022.
(60) Provisional application No. 63/379,761, filed on Oct. 16, 2022.

(51) Int. Cl. G06Q 40/08; G06N 20/00

(52) U.S. Cl. CPC G06Q 40/08; G06N 20/00

(57) ABSTRACT

Systems and methods for automatically approving prior authorization requests for an episode of service are described. An illustrative system may be used by insurance providers, clients, and third parties to request prior authorizations for episodes of service with real-time approvals if a requested service meets authorization criteria. Throughout each step of the authorization process, transactional information is logged and securely sent to all key parties using the blockchain.

### CROSS-REFERENCE TO RELATED APPLICATIONS

This application claims priority to U.S. Provisional Patent Application 63/379,760, titled “AUTOMATED PREAUTHORIZATION USING BLOCKCHAIN,” filed on Oct. 16, 2022, and U.S. Provisional Patent Application 63/379,761, titled “SYSTEMS AND METHODS FOR EXTRACTING INFORMATION FROM SERVICE SUMMARIES,” filed on Oct. 16, 2022, each of which is hereby incorporated by reference herein in their entirety.

### BACKGROUND

Traditional preauthorization processes are time consuming for both the client and the provider. The processes typically rely on extensive manual review. Additionally, the processes lack a means of transparent documentation.

Natural language processing algorithms have been adapted to automatically extract topics and answer questions based on a document.

A blockchain is a list of transactional records. Each record comprises a transaction, a timestamp, and a link to the previous record. Blockchain technology allows for both data security and transparency. Data recorded in the blockchain is designed to be resistant to manipulation through decentralization and the usage of a consensus algorithm. Furthermore, all relevant entities may access the data through the usage or private decryption keys.

A system is needed that establishes a secure automated validation of the documentation of prerequisites, guidelines, and rules through a series of machine learning and blockchain algorithms.

### SUMMARY

In some aspects, the techniques described herein relate to a method for automatically validating an authorization request for an episode of service including: receiving authorization information from one or more sources via a network, wherein the authorization information includes a combination of structured and unstructured information, and wherein the authorization information includes an authorization request and one or more requirements; converting the authorization information into structured, encrypted information; storing the structured, encrypted format using a blockchain; automatically determining an approval status of the authorization request based on the one or more requirements; storing the approval status, in an encrypted format, using the blockchain; automatically generating a message containing the approval status; and transmitting the message to the one or more sources.

In some aspects, the techniques described herein relate to a method, wherein automatically determining an approval status includes: collecting a set of authorization requests and requirements; creating a training set based on the set of authorization requests and requirements; training a natural language processor on the training set; and verifying the approval status using the natural language processor.

In some aspects, the techniques described herein relate to a method, wherein automatically determining an approval status includes validating an insured status of a user associated with the authorization request.

In some aspects, the techniques described herein relate to a method, wherein automatically determining an approval status includes validating coverage of a service request associated with the authorization request.

In some aspects, the techniques described herein relate to a method, wherein automatically determining an approval status includes reconciling insurance pre-requisites associated with the authorization request.

In some aspects, the techniques described herein relate to a method, wherein the one or more requirements include one or more natural language questions.

In some aspects, the techniques described herein relate to a method, wherein each of the one or more sources has real-time access to the encrypted blockchain.

In some aspects, the techniques described herein relate to a method, wherein each of the one or more sources has a private key for decrypting at least a portion of the blockchain.

In some aspects, the techniques described herein relate to a method, wherein the requirements include at least one of: national, regional, and state payer requirements.

In some aspects, the techniques described herein relate to a method, wherein the episode of service includes at least one of: a medical diagnosis, a car repair estimate, a home repair estimate, or a life insurance summary.

In some aspects, the techniques described herein relate to a system for automatically validating an authorization request for an episode of service including: a processor; and a non-transitory, processor-readable storage medium, wherein the non-transitory, processor-readable storage medium includes one or more programming instructions that, when executed, cause the processor to: receive authorization information from one or more sources via a network, wherein the authorization information includes a combination of structured and unstructured information, and wherein the authorization information includes an authorization request and one or more requirements; convert the authorization information into structured, encrypted information; store the structured, encrypted format using a blockchain; automatically determine an approval status of the authorization request based on the one or more requirements; store the approval status, in an encrypted format, using the blockchain; automatically generate a message containing the approval status; and transmit the message to the one or more sources.

In some aspects, the techniques described herein relate to a system, wherein the one or more programming instructions that, when executed, cause the processor to automatically determine an approval status further includes one or more programming instructions that, when executed, cause the processor to: collect a set of authorization requests and requirements; create a training set based on the set of authorization requests and requirements; train a natural language processor on the training set; and verify the approval status using the natural language processor.

In some aspects, the techniques described herein relate to a system, wherein the one or more programming instructions that, when executed, cause the processor to automatically determine an approval status further includes one or more programming instructions that, when executed, cause the processor to validate an insured status of a user associated with the authorization request.

In some aspects, the techniques described herein relate to a system, wherein the one or more programming instructions that, when executed, cause the processor to automatically determine an approval status further includes one or more programming instructions that, when executed, cause the processor to validate coverage of a service request associated with the authorization request.

In some aspects, the techniques described herein relate to a system, wherein the one or more programming instructions that, when executed, cause the processor to automatically determine an approval status further includes one or more programming instructions that, when executed, cause the processor to reconcile insurance pre-requisites associated with the authorization request.

In some aspects, the techniques described herein relate to a system, wherein the one or more requirements include one or more natural language questions.

In some aspects, the techniques described herein relate to a system, wherein each of the one or more sources has real-time access to the encrypted blockchain.

In some aspects, the techniques described herein relate to a system, wherein each of the one or more sources has a private key for decrypting at least a portion of the blockchain.

In some aspects, the techniques described herein relate to a system, wherein the requirements include at least one of: national, regional, and state payer requirements.

In some aspects, the techniques described herein relate to a system, wherein the episode of service includes at least one of: a medical diagnosis, a car repair estimate, a home repair estimate, or a life insurance summary.

### BRIEF DESCRIPTION OF THE DRAWINGS

Aspects and embodiments of this application are depicted in the figures, wherein:

FIG. 1 depicts a block diagram of an illustrative system, data, and internal processes performed in accordance with an embodiment.

FIG. 2 depicts a flow diagram of an illustrative method for automatic preauthorization using blockchain in accordance with an embodiment.

FIG. 3 depicts a flow diagram of an illustrative method for determining an authorization status in accordance with an embodiment.

FIG. 4 depicts a block diagram of an illustrative data processing system comprising internal hardware that may be used to contain or implement various computer processes and systems.

### DETAILED DESCRIPTION OF EMBODIMENTS

This disclosure is not limited to the particular systems, devices and methods described, as these may vary. The terminology used in the description is for the purpose of describing the particular versions or embodiments only and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” and “the” include plural references, unless the context clearly dictates otherwise. Thus, for example, reference to a “cell” is a reference to one or more cells and equivalents thereof known to those skilled in the art, and so forth.

As used herein, the term “about” means plus or minus 10% of the numerical value of the number with which it is being used. Therefore, about 50 mm means in the range of 45 mm to 55 mm.

As used herein, the term “consists of” or “consisting of” means that the device or method includes only the elements, steps, or ingredients specifically recited in the particular claimed embodiment or claim.

In embodiments or claims where the term “comprising” is used as the transition phrase, such embodiments can also be envisioned with replacement of the term “comprising” with the terms “consisting of” or “consisting essentially of.”

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art, all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components as well as the range of values greater than or equal to 1 component and less than or equal to 3 components. Similarly, a group having 1-5 components refers to groups having 1, 2, 3, 4, or 5 components, as well as the range of values greater than or equal to 1 component and less than or equal to 5 components, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

While the present disclosure has been illustrated by the description of exemplary embodiments thereof, and while the embodiments have been described in certain detail, the Applicant does not intend to restrict or in any way limit the scope of the appended claims to such detail. Additional advantages and modifications will readily appear to those skilled in the art. Therefore, the disclosure in its broader aspects is not limited to any of the specific details, representative devices and methods, and/or illustrative examples shown and described. Accordingly, departures may be made from such details without departing from the spirit or scope of the Applicant's general inventive concept.

Many of the examples presented herein reference health insurance. A person of ordinary skill in the art will recognize that these methods may be applied to other types of insurance, including, but not limited to, homeowners, renters, automotive, disability, identity theft, life, life settlement, viatical settlement, umbrella, and business

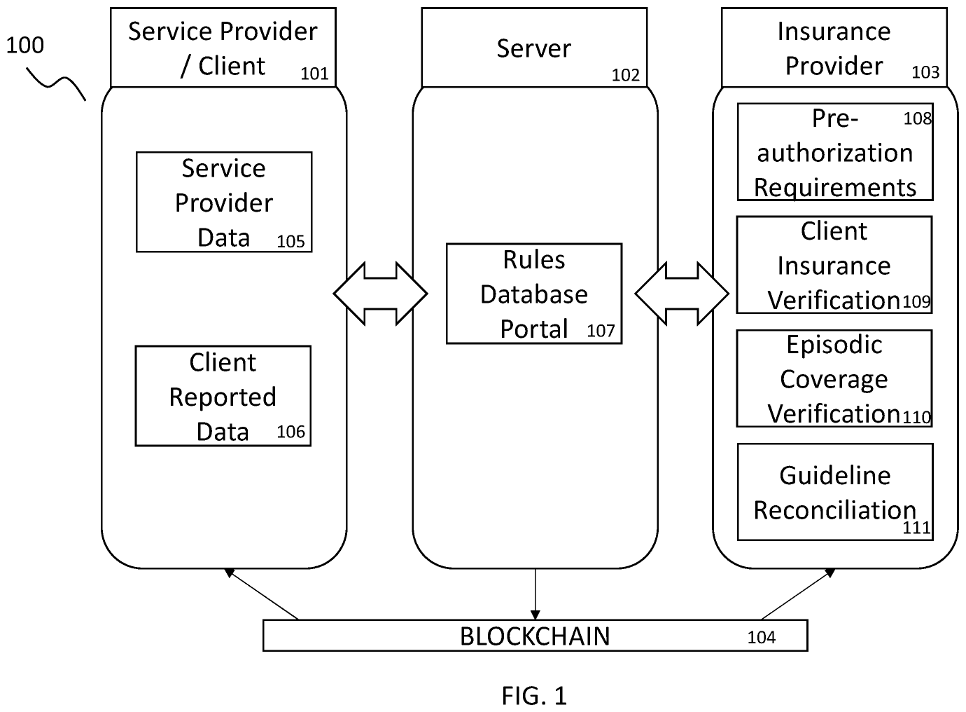

Referring to FIG. 1, a system 100 for providing prior authorization in accordance with an embodiment is depicted. In certain embodiments, a client device 101 submits data including an authorization request to a server 102. In some embodiments, the data is associated with a service provider 105 and/or a client 106. The data may detail an episode of service. For example, the episode of service may include a medical diagnosis, a car repair estimate, a home repair estimate, or a life insurance summary.

In some embodiments, the data includes at least one of member-identifying data and information associated with the coverage request. In some embodiments, the server 102 comprises a rules database server portal 107. In some embodiments, the rules database server 107 may be part of a group provider computer system such as those available through insurance companies. In alternative embodiments, the rules database server 107 may be a trusted third party.

In certain embodiments, the rules database server 107 may store all required rules and associated data. In alternative embodiments, the rules database server 107 may be in active communication with an insurance provider 103 server hosting the rules and associated data. In some embodiments, the rules and associated data may include preauthorization requirements 108, client insurance verification information 109, episodic coverage information 110, and guidelines 111.

In certain embodiments, the rules database server 107 compares the request to rules related to a client's plan benefits and preauthorization criteria to determine an authorization status. In some embodiments, the request is also logged using a blockchain 104 so that information about the transaction can be recorded and accessed for later retrieval and verification.

In certain embodiments, logging using the blockchain 104 may be used throughout the preauthorization process. The logging process may provide transparency and quality assurance to all relevant entities (i.e., the service provider/client 101 and the insurance provider 103). In some embodiments, the blockchain 104 may be stored in a transaction computer system. The transaction computer system may be managed by a third-party entity. In some embodiments, the blockchain 104 may be stored in a decentralized network. In some embodiments, the blockchain 104 may be a programmable blockchain (e.g., Ethereum) configured to store additional data other than the logged information described herein. As an example, the blockchain 104 may also include a cryptocurrency configured to incentivize verification of the blockchain 104. In some embodiments, the data stored using the blockchain 104 is encrypted. In further embodiments, the service provider, client, and insurance provider may each have their own private key for decrypting at least a portion of the data. In some embodiments, each authorization request may comprise a blockchain transaction reference number.

In certain embodiments, the rules database server 107 applies the authorization criteria to the service request. In some embodiments, the authorization status (e.g., approved, declined, needs further review) is then logged, using the blockchain 104, and an authorization transaction is communicated to the client and or any other third-party benefits manager computer system as an encrypted secure transaction accessible to all parties.

In certain embodiments, if the service request does not meet the authorization criteria, it may be flagged for review. In some embodiments, a review process may include a reviewer accessing the logged transaction from the blockchain 104. The reviewer may further request additional information from the client and or a third party and complete an assessment of the request and appropriate authorization criteria. In certain embodiments, if the request meets the authorization criteria, the request transaction may be updated using the blockchain 104. In some embodiments, the approval decision and an authorization transaction are automatically communicated to the client and or any other delegated third party. In some embodiments, the client and/or third party is notified that the request was submitted for review.

In certain embodiments, a client and/or third party may be notified that no prior authorization is required for a particular episode of service based on preauthorization requirements 108. As a result, the service provider does not need to spend time obtaining authorization for the request and can immediately send the client to the required service. In addition, the insurance provider 103 saves resources required to inform the client and or any other third party that no prior authorization is necessary for the episode of service.

In certain embodiments, a service provider may use a computing device to process a request. In some embodiments, the request may include member-identifying data and request-identifying data. In some embodiments, the service provider may be able to receive preauthorization directly prior to the scheduled episode of service.

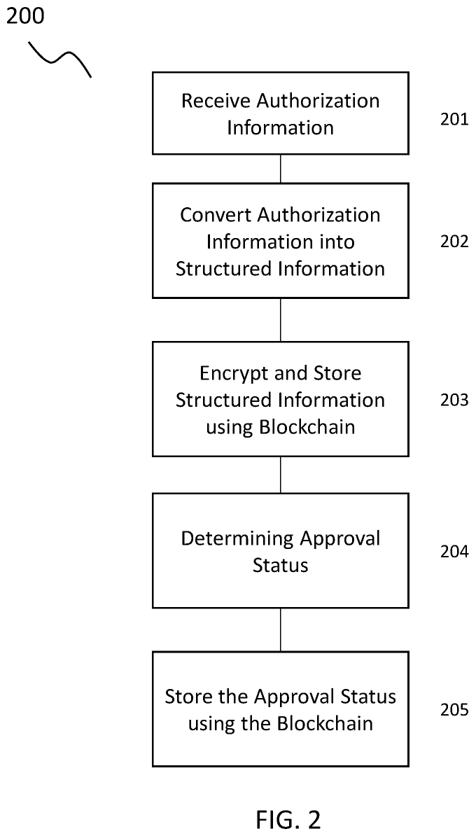

Referring to FIG. 2, a flow diagram of an illustrative method for automatic preauthorization using blockchain 200 is depicted in accordance with an embodiment. In certain embodiments, the method may include receiving authorization information 201 from one or more parties. In some embodiments, the one or more parties may comprise a client, a service provider, an insurance provider, and/or any other party (e.g., an employer). In some embodiments, the received authorization information may include structured and unstructured information. In some embodiments, the structured information may be in multiple formats. In some embodiments, the submitted information may be encrypted and stored using blockchain.

In certain embodiments, the method may include converting the authorization information into structured information 202. In some embodiments, converting the authorization information into structured information 202 may include at least one of optical character recognition (OCR) and natural language processing. In some embodiments, the natural language processor may be trained on a set of authorization requests and requirements to identify key information in the request. In some embodiments, the key information in an authorization request may include at least one of a client and/or service provider name, client and/or service provider contact information, a client member number, a client group number, a plan code, a plan type, a prescription group, a prescription identification number, a processor control number, a procedure, an ontology, a service provider location, a practitioner associated the service provider, a recommending/prescribing physician, a service, and a price. In some embodiments, the key information in insurance provider requirements may include at least one of preauthorization requirements, client insurance verification information, episodic coverage information, and guidelines. In some embodiments, the episodic information may be specific to one or more insurance plans. In some embodiments, the natural language processor may be doc2vec. In some embodiments, the structured information may be encrypted and stored using blockchain 203.

In certain embodiments, the method may include determining an approval status 204 for the authorization request. In some embodiments, determining an approval status 204 may include applying a natural language processor on at least a portion of the structured information or authorization information. In some embodiments, the natural language processor may be a question-answering machine learning algorithm. In some embodiments, an approval status may notate that the request is approved, is declined, needs further review, is reviewed and approved, or reviewed and declined. In some embodiments, the approval status may be encrypted and stored using blockchain 205.

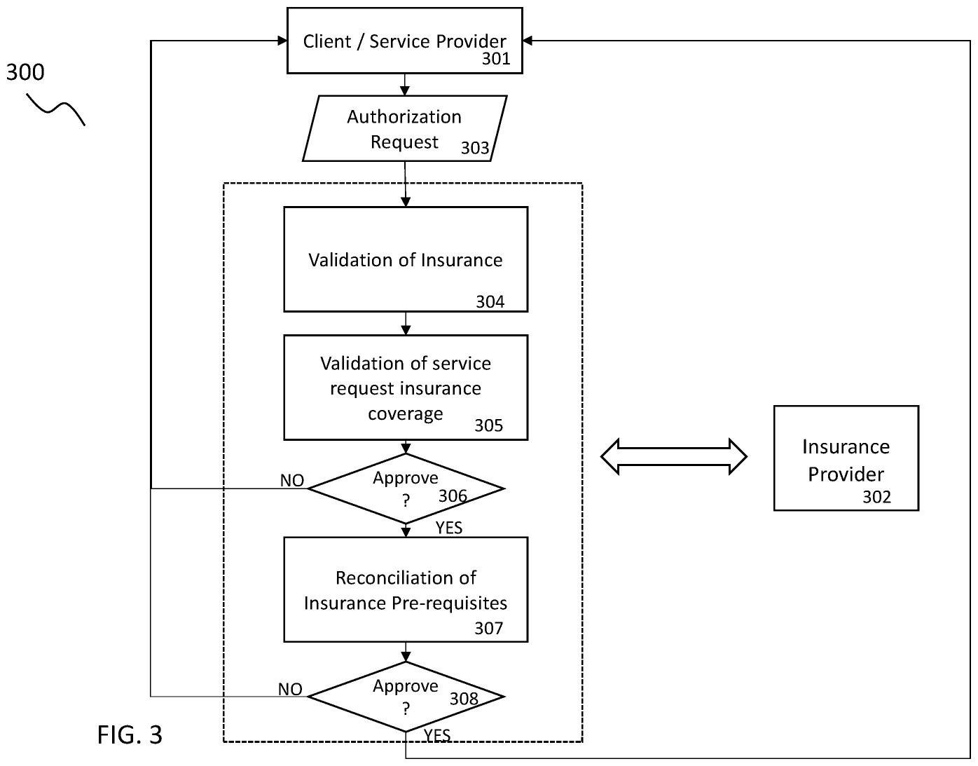

Referring to FIG. 3, a flow diagram of an illustrative method for determining an authorization status 300 in accordance with an embodiment is depicted. In certain embodiments, a system accepts 303 authorization information from a client and/or a service provider 301. In some embodiments, the client and/or service provider may submit the authorization information through any of a handheld device, a computer, a fax machine, or any other networked electronic device. In further embodiments, the device is a point-of-sale computer system. In some embodiments, clients and/or service providers may submit authorization information through at least one of a web portal in a browser, an application, an email, an SMS message, or a fax. In some embodiments, the client and/or service provider may similarly receive updates to the blockchain regarding the authorization using a web portal in a browser, an application, an email, an SMS message, or a fax.

In certain embodiments, the client and/or service provider may provide all information relevant to a service request in a single submission. In alternative embodiments, the client and/or service provider may enter data in a step-by-step process. Advantages are recognized for both methods of submission, and a single system may be configured to accept either method. For example, a single submission method may include faxing a traditional authorization request allowing a service provider to continue using their current systems. As another example, a step-by-step submission may include a form in a web portal which notifies the submitter if no preauthorization is required prior to all information being entered.

In certain embodiments, submitting authorization information may require authentication with the system. In some embodiments, authentication may include at least one of a name, password, member identification number, tax identification number, phone number, or fax number. One of ordinary skill in the art will recognize that any identifying information may be useful for authentication purposes.

In certain embodiments, the system validates 304 the client's insurance. In some embodiments, key information for validating insurance 304 may include client eligibility information such as a member or subscriber identifier or plan type. In some embodiments, one or more persons may be associated with the identification information requiring the identification of one of the persons associated with the identification information for whom the authorization request 303 will be made. In some embodiments, the insurance validation status may be logged using blockchain.

In certain embodiments, the system validates 305 insurance coverage for the episode of service detailed in the authorization request. In some embodiments, coverage validation 305 further comprises identifying information within the request. In some embodiments, information may be identified through natural learning processing as described herein. In an alternative embodiment, the client and/or service provider to select a service from a list of services. In some embodiments, the list may only include services requiring preauthorization. In some embodiments, the service provider may be prompted to respond to a series of questions regarding the requested service to facilitate auto-approval of the service. In some embodiments, the insurance coverage approval status may be logged using blockchain 306.

In certain embodiments, the service request is recorded in a claims database that comprises information about each client's claims history. In some embodiments, the claims database may comprise one or more references to blockchain transaction reference numbers. In some embodiments, a contact history record is recorded using blockchain for all transactions processed through the system. In some embodiments, a contact history record may be used for quality assurance and review in respect to cases which are not automatically approved, to track approved cases, and/or to troubleshoot incoming questions about the transactions via client calls. In some embodiments, each transaction may have at least one of a recorded category, reason, and disposition.

In certain embodiments, some services may be automatically approved for preauthorization based on at least one of validation of insurance (e.g., a service required for all insurance policies under the Affordable Care Act), or validation of coverage (e.g., a common service). In some embodiments, some services may require an additional reconciliation of insurance prerequisites by a reviewer 307.

In certain embodiments, if the service request does not meet the auto-approval authorization criteria, it is submitted for external review 307. In some embodiments, the review status may be logged 308 using blockchain. In some embodiments, the client and/or service provider may be notified that the service request did not complete the auto-approval process and has been submitted to a review division for further consideration. In some embodiments, the review request may include at least one of the original service request and a claim history associated with the client from the insurance provider 302. Additional information from the client's service provider may also accompany the review request. In some embodiments, after review, the approval status may again be updated using blockchain.

In certain embodiments, a form letter confirming the transaction and results may be generated and transmitted or mailed upon completion of the transaction.

In certain embodiments, the systems described herein may be accessible via a web portal. In some embodiments, web pages, including uniform resource locators, for provider selection, client selection, service selection, and flow and decision pages (e.g., approved, declined, not required, etc.) are dynamically generated based on user information and stored. In some embodiments, the full client or service provider history may be available as sourced from the blockchain.

### Example Computer System

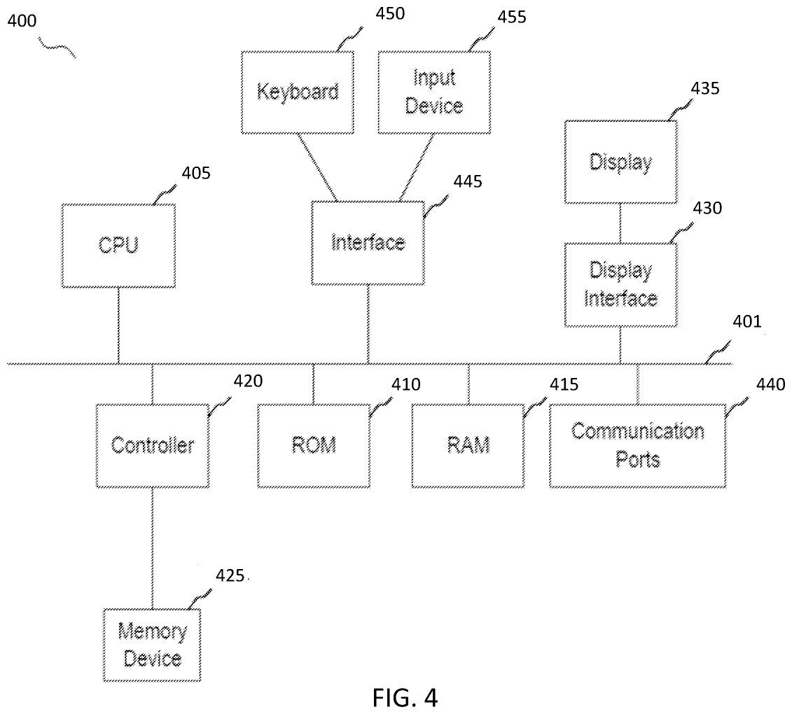

FIG. 4 depicts a block diagram of exemplary data processing system 400 comprising internal hardware that may be used to contain or implement the various computer processes and systems as discussed above. In some embodiments, the exemplary internal hardware may include or may be formed as part of a database control system. In some embodiments, the exemplary internal hardware may include or may be formed as part of an additive manufacturing control system, such as a three-dimensional printing system. A bus 401 serves as the main information highway interconnecting the other illustrated components of the hardware. CPU 405 is the central processing unit of the system, performing calculations and logic operations required to execute a program. CPU 405 is an exemplary processing device, computing device or processor as such terms are used within this disclosure. Read only memory (ROM) 410 and random access memory (RAM) 415 constitute exemplary memory devices.

A controller 420 interfaces with one or more optional memory devices 425 via the system bus 401. These memory devices 425 may include, for example, an external or internal DVD drive, a CD ROM drive, a hard drive, flash memory, a USB drive or the like. As indicated previously, these various drives and controllers are optional devices. Additionally, the memory devices 425 may be configured to include individual files for storing any software modules or instructions, data, common files, or one or more databases for storing data.

Program instructions, software or interactive modules for performing any of the functional steps described above may be stored in the ROM 410 and/or the RAM 415. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 430 can permit information from the bus 401 to be displayed on the display 435 in audio, visual, graphic or alphanumeric format. Communication with external devices can occur using various communication ports 440. An exemplary communication port 440 can be attached to a communications network, such as the Internet or a local area network.

The hardware can also include an interface 445 which allows for receipt of data from input devices such as a keyboard 450 or other input device 455 such as a mouse, a joystick, a touch screen, a remote control, a pointing device, a video input device and/or an audio input device.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Instead, this application is intended to cover any variations, uses, or adaptations of the present teachings and use its general principles. Further, this application is intended to cover such departures from the present disclosure as come within known or customary practice in the art to which these teachings pertain. Many modifications and variations can be made to the particular embodiments described without departing from the spirit and scope of the present disclosure as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method for automatically validating an authorization request for an episode of service comprising:
receiving information from one or more sources via a network, wherein the information comprises a combination of structured and unstructured information, and wherein the information comprises an authorization request and one or more requirements;
converting the information into structured, encrypted information;
storing the structured, encrypted format using a blockchain;
automatically determining an approval status of the authorization request based on the one or more requirements;
storing the approval status, in an encrypted format, using the blockchain;
automatically generating a message containing the approval status; and
transmitting the message to the one or more sources.

2. The method of claim 1, wherein automatically determining an approval status comprises:
collecting a plurality of authorization requests and requirements;
creating a training set based on the plurality of authorization requests and requirements;
training a natural language processor on the training set; and
verifying the approval status using the natural language processor.

3. The method of claim 1, wherein automatically determining an approval status comprises validating an insured status of a user associated with the authorization request.

4. The method of claim 1, wherein automatically determining an approval status comprises validating coverage of a service request associated with the authorization request.

5. The method of claim 1, wherein automatically determining an approval status comprises reconciling insurance pre-requisites associated with the authorization request.

6. The method of claim 1, wherein the one or more requirements comprise one or more natural language questions.

7. The method of claim 1, wherein each of the one or more sources has real-time access to the encrypted blockchain.

8. The method of claim 7, wherein each of the one or more sources has a private key for decrypting at least a portion of the blockchain.

9. The method of claim 1, wherein the requirements comprise at least one of: national, regional, and state payer requirements.

10. The method of claim 1, wherein the episode of service comprises at least one of: a medical diagnosis, a car repair estimate, a home repair estimate, or a life insurance summary.

11. A system for automatically validating an authorization request for an episode of service comprising:
a processor; and
a non-transitory, processor-readable storage medium, wherein the non-transitory, processor-readable storage medium comprises one or more programming instructions that, when executed, cause the processor to:
receive information from one or more sources via a network, wherein the information comprises a combination of structured and unstructured information, and wherein the information comprises an authorization request and one or more requirements;
convert the information into structured, encrypted information;
store the structured, encrypted format using a blockchain;
automatically determine an approval status of the authorization request based on the one or more requirements;
store the approval status, in an encrypted format, using the blockchain;
automatically generate a message containing the approval status; and
transmit the message to the one or more sources.

12. The system of claim 11, wherein the one or more programming instructions that, when executed, cause the processor to automatically determine an approval status further comprises one or more programming instructions that, when executed, cause the processor to:
collect a plurality of authorization requests and requirements;
create a training set based on the plurality of authorization requests and requirements;
train a natural language processor on the training set; and
verify the approval status using the natural language processor.

13. The system of claim 11, wherein the one or more programming instructions that, when executed, cause the processor to automatically determine an approval status further comprises one or more programming instructions that, when executed, cause the processor to validate an insured status of a user associated with the authorization request.

14. The system of claim 11, wherein the one or more programming instructions that, when executed, cause the processor to automatically determine an approval status further comprises one or more programming instructions that, when executed, cause the processor to validate coverage of a service request associated with the authorization request.

15. The system of claim 11, wherein the one or more programming instructions that, when executed, cause the processor to automatically determine an approval status further comprises one or more programming instructions that, when executed, cause the processor to reconcile insurance pre-requisites associated with the authorization request.

16. The system of claim 11, wherein the one or more requirements comprise one or more natural language questions.

17. The system of claim 11, wherein each of the one or more sources has real-time access to the encrypted blockchain.

18. The system of claim 17, wherein each of the one or more sources has a private key for decrypting at least a portion of the blockchain.

19. The system of claim 11, wherein the requirements comprise at least one of: national, regional, and state payer requirements.

20. The system of claim 11, wherein the episode of service comprises at least one of: a medical diagnosis, a car repair estimate, a home repair estimate, or a life insurance summary.
